(19) United States
(12) Patent Application Publication
(10) Pub. No.: US 2015/0128473 A1
(43) Pub. Date: May 14, 2015

(54) QUICK ATTACH AND RELEASE FISHING TACKLE WITH ROTATION CONTROL SURFACE

(71) Applicants: Alexander T. Kim, Saratoga, CA (US); Darren C. Kim, Oakland, CA (US)

(72) Inventors: Darren C. KIM, Oakland, CA (US); Alexander T. Kim, Saratoga, CA (US)

(21) Appl. No.: 14/076,032

(22) Filed: Nov. 8, 2013

(51) Int. Cl. A01K 85/00; A01K 95/02; A01K 93/00

(52) U.S. Cl. CPC A01K 85/00; A01K 93/00; A01K 95/02
USPC 43/17.5; 43/43.13

(57) ABSTRACT

A helical groove fishing tackle, which may be a sinker, a bullet rotator, a lure, a bobbler, or the like, is configured with one or more rotation control surfaces to counteract the spinning caused by water flowing across the helical grooves. The rotation control surfaces may be fins or keels, protrusions, or grooves, provided on an outer surface of the fishing tackle.

### BACKGROUND

A lead sinker is one of the basic equipment in all fishermen's tackle box. It is the weight that lowers baited hooks or lures down to the desired depth in fresh or salt water. There are variety of sinker designs and weight options in existence.

The egg sinker is one of the most common designs used. Egg sinkers are shaped somewhat like an egg with a straight hole running down its longitudinal axis for the fishing line to pass through. All surfaces on the egg sinker are smooth to allow the sinker to easily slide up and down the fishing line, so that the biting fish feels little resistance from the sinker weight.

The disadvantage of the egg sinker design is the need for the line to be cut and retied every time a sinker is replaced. A skilled fisherman can quickly perform this task but it can become a hassle when it is done numerous times over the course of a day and fingers become raw from continued exposure to water. Also, there are occasions when quicker replacement method is desired because by the time the egg sinker is replaced and the angler is fishing again, the fish bite may have already shut down.

U.S. Pat. No. 2,599,973 discloses a “Slip-on Fishline Sinker” that is designed to be readily attached and connected to a fishing line without being tied thereto. The disclosed sinker has an elongated body formed with longitudinally-extending bore openings therethrough and the body is provided with a helical slot by which the fishing line is inserted into the openings.

One drawback of the sinker design of U.S. Pat. No. 2,599,973 is that the sinker rotates about its longitudinal axis. The sinker rotates like a turbine when water flows across the helical grooves and spins the sinker. The spinning motion against the fishing line creates additional wear leading to lower ultimate strength of the fishing line.

### SUMMARY

Embodiments provide a helical groove fishing tackle, which may be a sinker, a bullet rotator, a lure, a bobbler (also known as a float), or the like, that is configured to counteract the spinning caused by water flowing across the helical grooves. In one embodiment, fins or keels are provided on an outer surface of the fishing tackle to oppose the fishing tackle rotation. In another embodiment, slots are provided on an outer surface of the fishing tackle to oppose the fishing tackle rotation.

### BRIEF DESCRIPTION OF THE DRAWINGS

FIGS. 1A and 1B are perspective and top views of a sinker according to a first embodiment.

FIG. 2 is a perspective view of a sinker according to a second embodiment.

FIG. 3 is a perspective view of a sinker according to a third embodiment.

FIGS. 4A-4E are orthographic views of the sinker according to the third embodiment.

FIG. 5 illustrates a sinker according to a fourth embodiment.

FIG. 6 illustrates a sinker according to a fifth embodiment.

FIGS. 7A and 7B are perspective views of a sinker according to a sixth embodiment.

FIG. 8 illustrates a lure that incorporates the helical groove design with rotation control surfaces.

FIG. 9 illustrates a bullet rotator that incorporates the helical groove design with rotation control surfaces.

FIG. 10 illustrates a bobbler that incorporates the helical groove design with rotation control surfaces.

### DETAILED DESCRIPTION

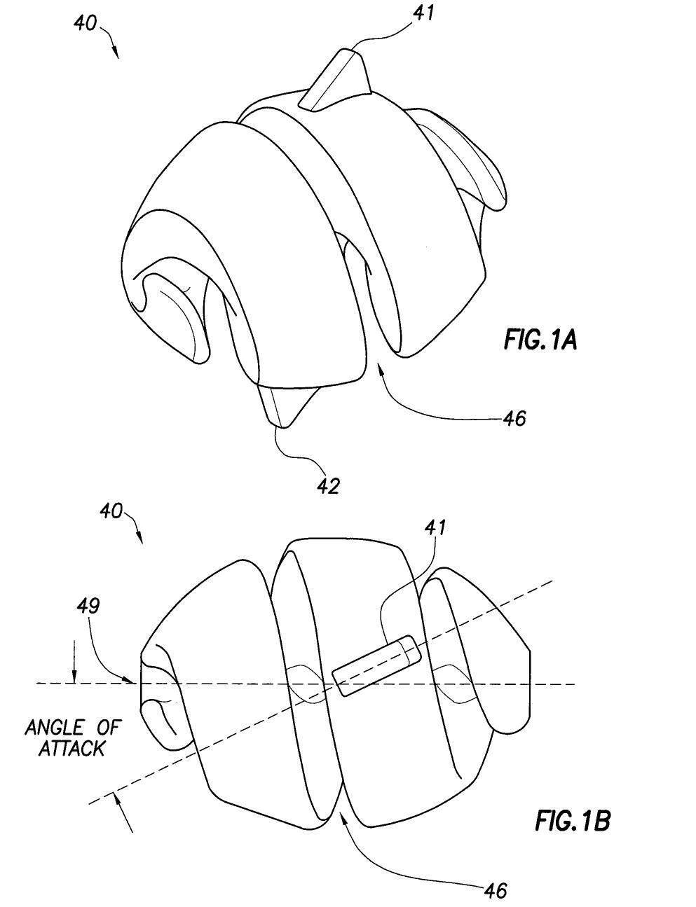

FIGS. 1A and 1B are perspective and top views of a sinker according to a first embodiment. Sinker 40 has a body (typically made of lead, but other dense materials may be used) with an elongated slot 49 extending through the center of the body of sinker 40 along its longitudinal axis. Helical groove 46 is formed around the body to permit a fishing line (not shown) to be inserted into and positioned within elongated slot 49 by winding the fishing line in through helical groove 46. When the fishing line is positioned within elongated slot, sinker 40 is deemed attached to the fishing line and operable for use during fishing. Sinker 40 is detached from the fishing line in a reverse manner, by unwinding the fishing line out through helical groove 46.

Fins 41, 42 (or keels) are formed on outer surfaces of sinker 40. Fins 41, 42 function as anti-rotation surfaces of sinker 40. When sinker 40 is attached to the fishing line and used during fishing, water flows past sinker 40, in particular across surfaces of helical groove 46, thereby urging sinker 40 to rotate. Fins 41, 42 prevent such rotation of sinker 40. Fins 41, 42 are formed with a control surface that is at a preconfigured angle of attack, e.g., 45 degrees, to counter the rotation of sinker 40 urged by water flowing across surfaces of helical groove 46. The angle of attack is preconfigured to be large enough to counter the rotation of sinker 40 urged by water flowing across surfaces of helical groove 46. By way of example, the angle of attack may be preconfigured as 10 degree to 45 degree. It should be recognized that the preconfigured angle of attack would be increased or decreased in accordance with the helical groove design. For helical groove designs that urge a greater rotation of sinker 40, the preconfigured angle of attack should be increased. For helical groove designs that urge a lesser rotation of sinker 40, the preconfigured angle of attack should be decreased.

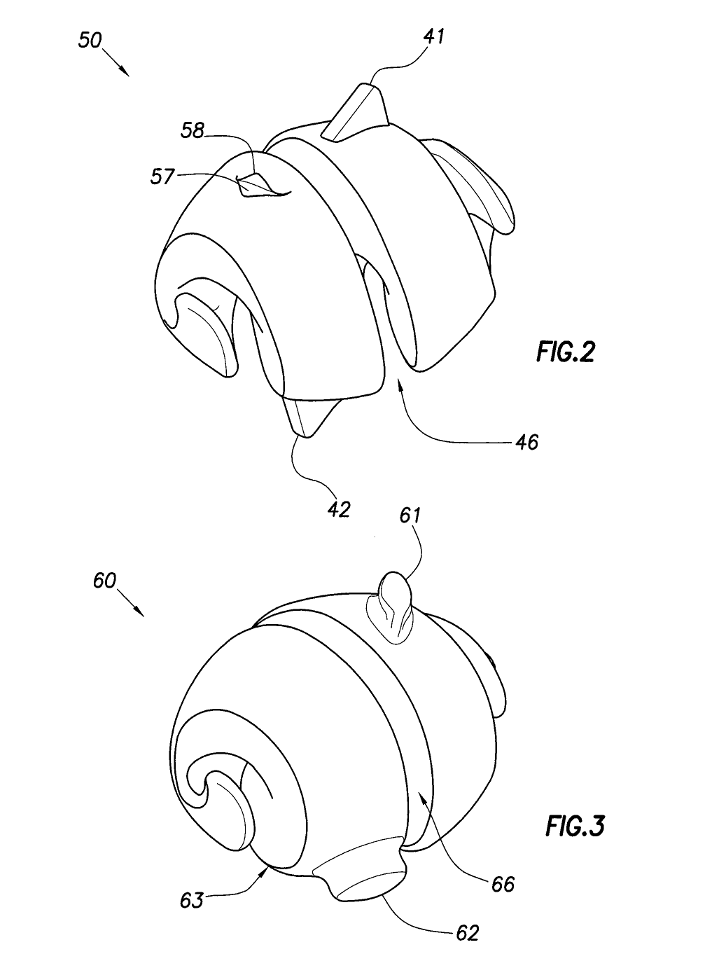

FIG. 2 is a perspective view of a sinker according to a second embodiment. Sinker 50 is identical to sinker 40 except its body is coated with resin 58. For illustrative purposes, FIG. 2 shows resin 58 partially peeled off and a part of body 57 that is covered by resin 58 that has been peeled off. When the body of sinker 50, which is typically lead or some other metal, is manufactured (through molding or some other process), sharp edges may be formed. The sharp edges are not desirable because they may cause the fishing line to be cut during use of sinker 50. The resin coating is applied by submersing the body of sinker 50 in a resin bath above a melting temperature of the resin and covers any sharp edges. Upon hardening, the resin coating covering the sharp edges protects the fishing line from being cut during use of sinker 50. The resin coating is also desirable because sinker 50 can be colored easily, simply by adding color to the resin bath. In a similar manner, fluorescence (useful for nighttime fishing) can be applied to sinker 50 by adding fluorescent materials to the resin bath.

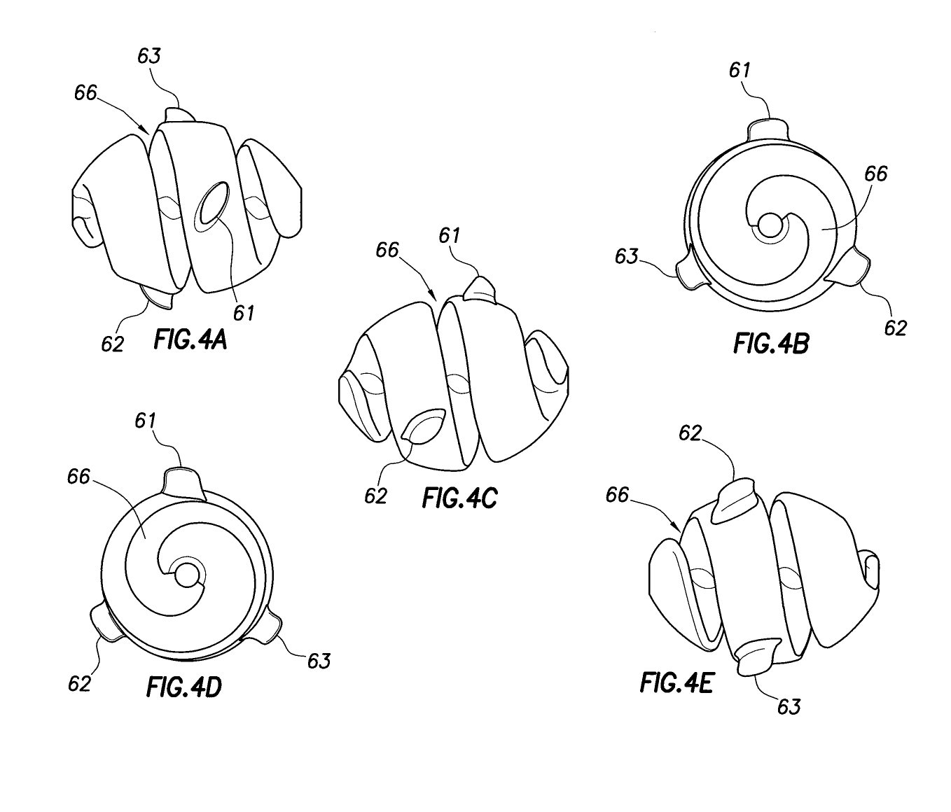

FIG. 3 is a perspective view of a sinker according to a third embodiment. FIGS. 4A-4E are orthographic views (respectively, top, left, front, right, and bottom) of the sinker according to the third embodiment. Sinker 60 has helical groove 66 which is configured in substantially the same manner as helical groove 46 of the first and second embodiments. The primary difference between the third embodiment and the first and second embodiments is in the fin design. Here, three fins 61, 62, 63 are formed on the outer surface of sinker 60.

FIG. 5 illustrates a sinker according to a fourth embodiment. Sinker 80 has helical groove 86 which is configured in substantially the same manner as helical groove 46 of the first and second embodiments. The primary difference between the fourth embodiment and the first and second embodiments is in the design of the rotation control surface. Here, multiple protrusions 81-85 are formed on the outer surface of sinker 80 as rotation control surfaces instead of fins.

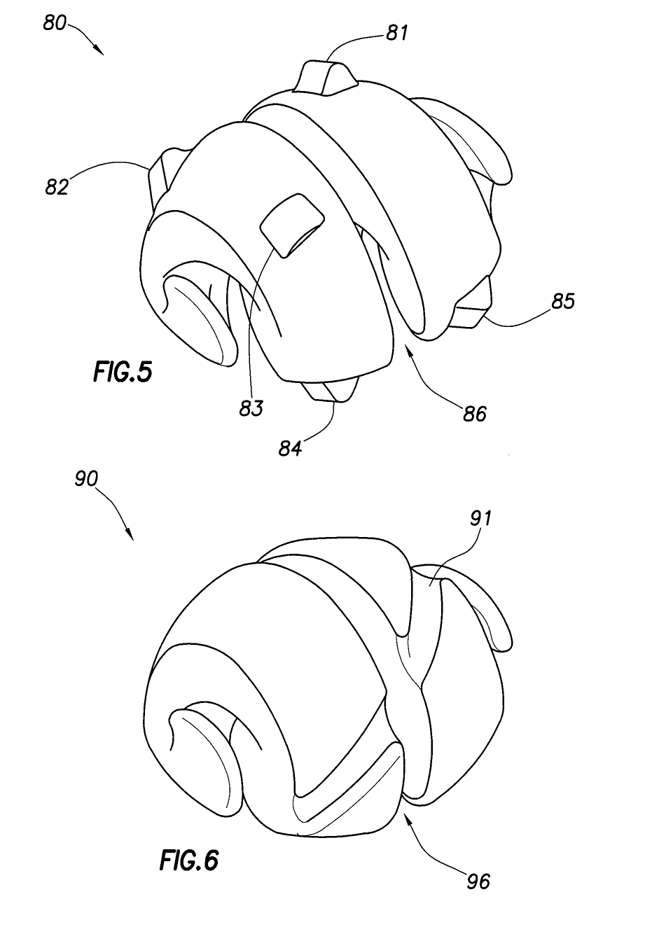

FIG. 6 illustrates a sinker according to a fifth embodiment. Sinker 90 has helical groove 96 which is configured in substantially the same manner as helical groove 46 of the first and second embodiments. The primary difference between the fifth embodiment and the first and second embodiments is in the design of the rotation control surface. Here, cutouts or grooves 91 are formed on the outer surface of sinker 90 as rotation control surfaces instead of fins.

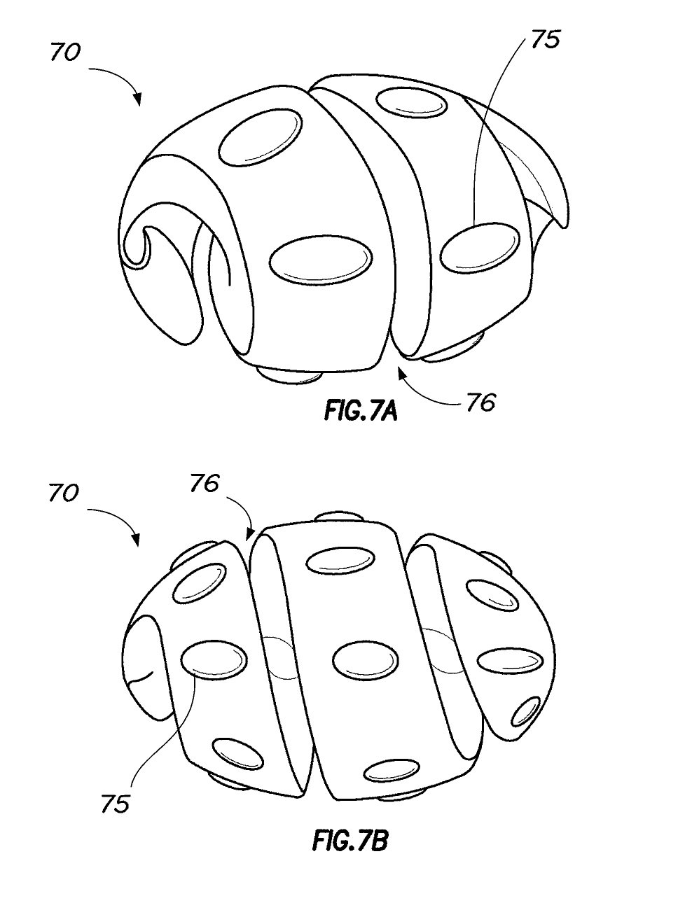

FIG. 7 illustrates a sinker according to a sixth embodiment. Sinker 70 has helical groove 76 which is configured in substantially the same manner as helical groove 46 of the first and second embodiments. The primary difference between the sixth embodiment and the first and second embodiments is in the design of the rotation control surface. Here, multiple oval-shaped protrusions 75 are formed on the outer surface of sinker 70 as rotation control surfaces instead of fins. Alternative to oval-shaped protrusions 75, protrusions having other shapes, e.g., spherical, may be used.

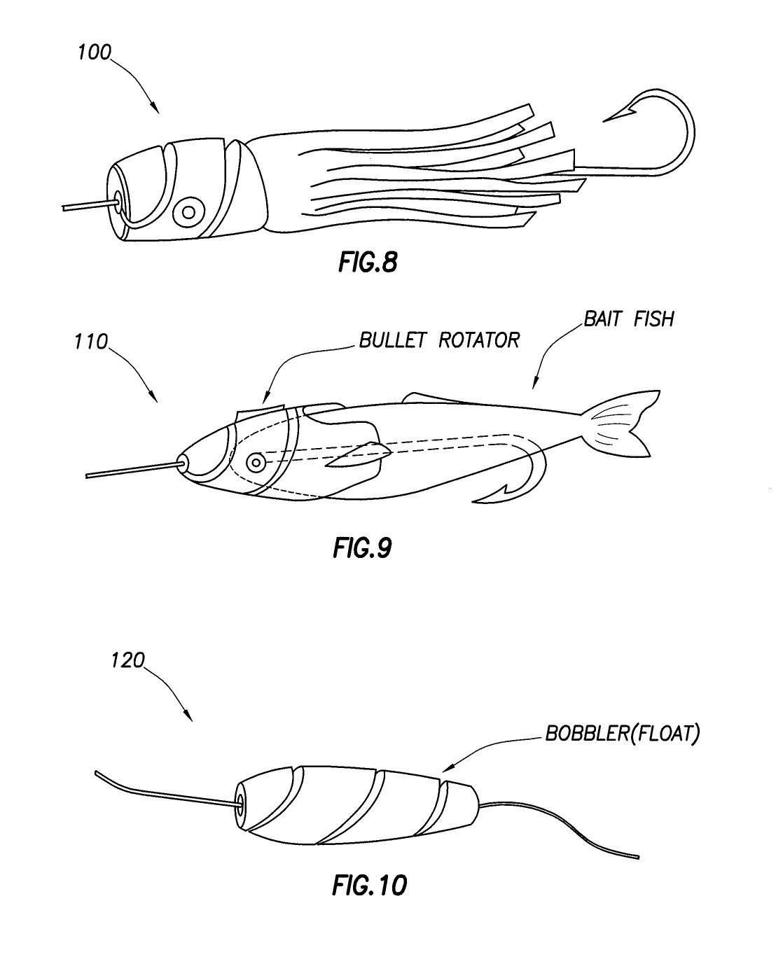

The above embodiments incorporate the helical groove design with rotation control surfaces in a sinker. The same design may be extended to other types of fishing tackle. FIG. 8 illustrates a lure that incorporates the helical groove design with rotation control surfaces. FIG. 9 illustrates a bullet rotator that incorporates the helical groove design with rotation control surfaces. FIG. 10 illustrates a bobbler that incorporates the helical groove design with rotation control surfaces.

In addition, the above embodiments incorporate the helical groove design with a certain type of helical groove and a certain number of rotation control surfaces. The type of helical groove may be varied as well as the number of control surfaces for optimum performance. In addition, in the embodiments employing fins, the angle of attack of the fins may be varied for optimal performance.

While the foregoing is directed to specific embodiments, other and further embodiments may be devised without departing from the basic scope thereof, and the scope thereof is determined by the claims that follow.

What is claimed is:

1. A fishing tackle comprising:
an elongated body having a slot that extends along a longitudinal axis of the body and a helical groove by which a fishing line is to be inserted into the slot; and
a rotation control surface formed on an outer surface of the body, the rotation control surface being configured to counteract a rotation of the body when water flows across the helical groove.

2. The fishing tackle of claim 1, wherein the rotation control surface includes one or more fins.

3. The fishing tackle of claim 2, wherein the fins have an angle of attack with respect to the longitudinal axis that is between 10 and 45 degrees.

4. The fishing tackle of claim 1, wherein the rotation control surface includes a plurality of projections.

5. The fishing tackle of claim 4, wherein the projections have an oval-shape.

6. The fishing tackle of claim 1, wherein the rotation control surface includes a groove.

7. The fishing tackle of claim 1, wherein the slot extends through a center longitudinal axis of the elongated body.

8. The fishing tackle of claim 1, wherein the fishing tackle is a sinker.

9. The fishing tackle of claim 1, wherein the fishing tackle is a bullet rotator.

10. The fishing tackle of claim 1, wherein the fishing tackle is a lure.

11. The fishing tackle of claim 1, wherein the fishing tackle is a bobbler.

12. A fishing tackle comprising:
an elongated body having a slot that extends along a longitudinal axis of the body and a helical groove by which a fishing line is to be inserted into the slot;
a coating that covers surfaces and edges of the elongated body; and
a rotation control surface formed on an outer surface of the body, the rotation control surface being configured to counteract a rotation of the body when water flows across the helical groove.

13. The fishing tackle of claim 11, wherein the coating covers the elongated body so that none of the edges of the elongated body are exposed.

14. The fishing tackle of claim 11, wherein the coating is a resin.

15. The fishing tackle of claim 11, wherein the coating is a colored coating.

16. The fishing tackle of claim 11, wherein the coating is a coating containing fluorescent materials.
